(19) United States
(12) Patent Application Publication
(10) Pub. No.: US 2007/0227336 A1
(43) Pub. Date: Oct. 4, 2007

(54) ELECTRONIC MUSICAL INSTRUMENT WITH DIRECT PRINTER INTERFACE

(75) Inventor: Atsushi FUKADA, Hamamatsu--shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 11/690,164

(22) Filed: Mar. 23, 2007

(30) Foreign Application Priority Data
Mar. 31, 2006 (JP) 2006-096691

(51) Int. Cl. G10H 1/00

(52) U.S. Cl. 84/600

(57) ABSTRACT

In an electronic musical instrument, a tone generator generates performance sounds of a music piece. A printer interface is provided for directly connecting a printer. An image data generation part generates image data of a musical score which corresponds to the music piece. A transmission part transmits the image data to the printer for allowing the printer to print the music score according to the transmitted image data. A print capability information acquisition part acquires print capability information representing a print capability of the connected printer. The image data generation part generates the image data in compliance with the acquired print capability information.

### BACKGROUND OF THE INVENTION

1. Technical Field

The present invention relates to an electronic musical instrument and a program suitable for use in printing a musical score and the like.

2. Related Art

Japanese Unexamined Patent Publication (Kokai) No. 2004-117487 discloses an electronic musical instrument that can be connected to a personal computer and a printer. According to the disclosed contents, the printer can print a musical score based on electronic musical score data stored in the personal computer, or the electronic musical instrument can generate musical sound based on musical performance data generated from the electronic musical score data.

Here, “electronic score data” is data created based on a specified rule with reference to an existing musical score, and is also a so-called logical score including: data defining notes; data for specifying types and display positions such as staff, clef, key signature, time signature, tempo mark, dynamic mark, repeat sign, and articulation symbol; instruction data for dividing notes into measures, staves, and pages; and image data for the respective symbols. Also, based on the electronic score data, a special-purpose application program is executed to synthesize score image data whose quality approximates to the existing musical score, to display the score image data, or to print the score image data by a printer.

However, in the case of printing a musical score in the above-mentioned technology, the electronic musical instrument cannot directly control the printer to print a musical score, but it is inevitably necessary to use the personal computer for printing the musical score.

### SUMMARY OF THE INVENTION

The present invention has been made in consideration of the foregoing, and it is therefore an object of the present invention to provide an electronic musical instrument and a program capable of directly controlling a printer to print a musical score.

To solve the above-mentioned problem, the present invention is constructed as follows.

Namely, an inventive electronic musical instrument comprises: a tone generating part that generates performance sounds of a music piece; a printer interface directly connected to a printer; an image data generation part that generates image data of a musical score which corresponds to the music piece; and a transmission part that transmits the image data to the printer for allowing the printer to print the music score according to the transmitted image data.

Preferably, the inventive electronic musical instrument further comprises a print capability information acquisition part that acquires print capability information representing a print capability of the connected printer, wherein the image data generation part generates the image data in compliance with the acquired print capability information.

Preferably, the inventive electronic musical instrument further comprises a download part that downloads musical score data representing the musical score via a network, wherein the image data generation part generates image data of the musical score based on the downloaded musical score data. In this case, the image data generation part generates image data of the musical score a page by page basis in case that the musical score data corresponds to a plurality of pages of the musical score. Further, the image data generation part interprets the musical score data which represents a logical format of the musical score, determines fonts of musical notations according to results of the interpreting of the musical score data, and creates the image data using the fonts.

Preferably, the inventive electronic musical instrument further comprises a musical performance data storage part that stores musical performance data which is used by the tone generating part to generate the performance sounds, wherein the image data generation part generates image data of the musical score based on the stored musical performance data. In this case, the image data generation part generates image data of the musical score a page by page basis when the musical performance data corresponds to a plurality of pages of the musical score. Further, the image data generation part interprets the musical performance data which represents a sequence of musical events of the musical piece, converts the musical events to corresponding musical notes, and arranges images of the corresponding musical notes on an image of staff to synthesize the image data.

An inventive machine readable medium is provided for use in an electronic musical instrument having a printer interface directly connected to a printer, a tone generator that generates performance sounds of a music piece, and a processor, the machine readable medium containing a program which is executable by the processor for causing the electronic musical instrument to perform a method comprising: an image data generation step of generating image data of a musical score which corresponds to the music piece; and a transmission step of transmitting the image data to the printer through the interface to allow the printer to print the musical score according to the transmitted image data.

As mentioned above, since the electric musical instrument according to the present invention is provided with a printer interface directly connected to a printer and a transmission part for transmitting image data to the printer and allowing the printer to print image data, it is possible to print a musical score by directly controlling the printer.

### BRIEF DESCRIPTION OF THE DRAWINGS

FIG. 1 is a block diagram of an electronic musical instrument according to an embodiment of the present invention.

FIGS. 2(a), 2(b) and 2(c) are diagrams describing an overview of a USB interface.

FIG. 3 is a flowchart of a download routine.

FIG. 4 is a flowchart of a print process main routine.

FIGS. 5(a) and 5(b) are flowcharts of subroutines for processing musical score data.

FIGS. 6(a) and 6(b) are flowcharts of subroutines for processing musical performance data.

### DETAILED DESCRIPTION OF THE INVENTION

1. Hardware Construction of an Embodiment

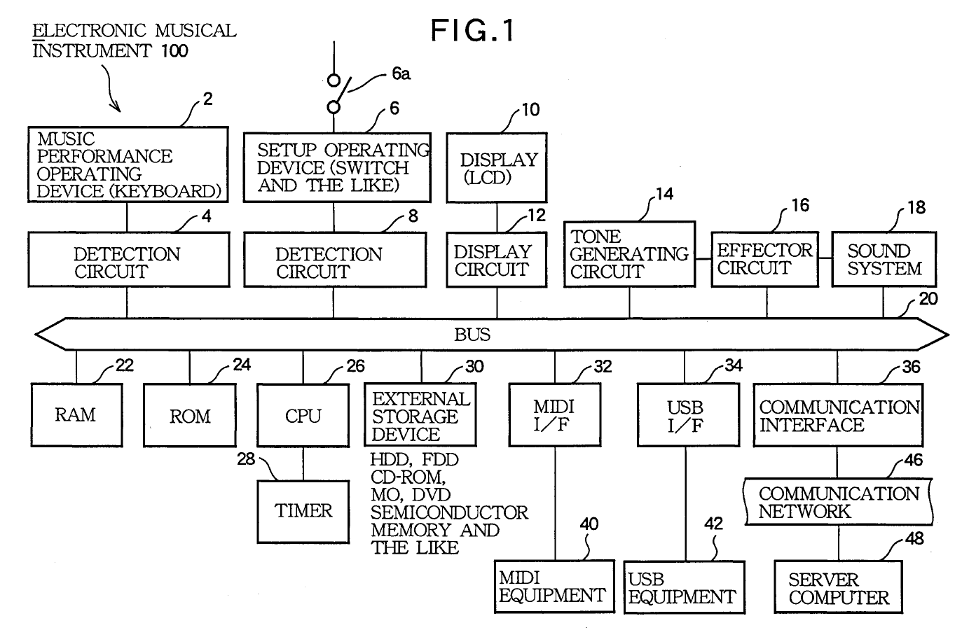

Referring now to FIG. 1, the following describes the construction of an electronic musical instrument 100 according to an embodiment of the invention.

In FIG. 1, reference numeral 2 denotes a music performance operating device including a keyboard and the like. Reference numeral 4 denotes a detection circuit that detects an operation state of the music performance operating device 2 and outputs the operation state via a bus 20. Reference numeral 10 denotes a dot-matrix LCD display that is driven by a display circuit 12, and displays various information based on a display command supplied from a CPU 26 to the display circuit 12. Reference numeral 6 denotes a setup operating device including various operating devices for setting various operation states of the electronic musical instrument 100. Especially, the setup operating device 6 according to the embodiment is provided with a printing indicating button 6a for controlling printing of a file and the like displayed on the display 10. Reference numeral 8 denotes a detection circuit that detects an operation state of the setup operating device 6. Reference numeral 14 denotes a tone generating circuit that generates musical sound signals of a music piece based on music performance data supplied from the CPU 26. Reference numeral 16 denotes an effector circuit that provides the musical sound signal with a special effect.

Reference numeral 18 denotes a sound system that generates a musical sound signal output from the effector circuit 16. Reference numeral 26 denotes a CPU that controls the other elements via the bus 20 based on a program stored in ROM 24 which is a machine readable medium. Reference numeral 22 denotes RAM that is used as work memory for the CPU 26. Reference numeral 28 denotes a timer that keeps track of the current time and allows the CPU 26 to generate a timer interrupt as needed. Reference numeral 30 denotes an external storage device including storage media such as a hard disk, flexible disk, CD-ROM, MO, DVD, and semiconductor memory and associated drive apparatuses. Reference numeral 32 denotes a MIDI interface that transfers a MIDI signal to and from an external MIDI equipment 40. Reference numeral 34 denotes a USB interface that transfers a serial signal to and from an external USB equipment 42. Reference numeral 36 denotes a communication interface that is connected to a server computer and the like via an external communication network 46.

2. USB Connection Protocol

The following describes a protocol for the USB interface 34 and the USB device 42. Equipments that perform data communication using a USB cable are called as “USB equipments”. Accordingly, the electronic musical instrument 100 and the USB device 42 in FIG. 1 are both “USB equipments.” The USB equipments are classified into a “USB host” and a “USB device.” When the USB host issues a command, the USB device returns a response to implement communication between them. Since the electronic musical instrument 100 operates as a USB device, the USB equipment 42 connected to the USB interface 34 must be a USB host.

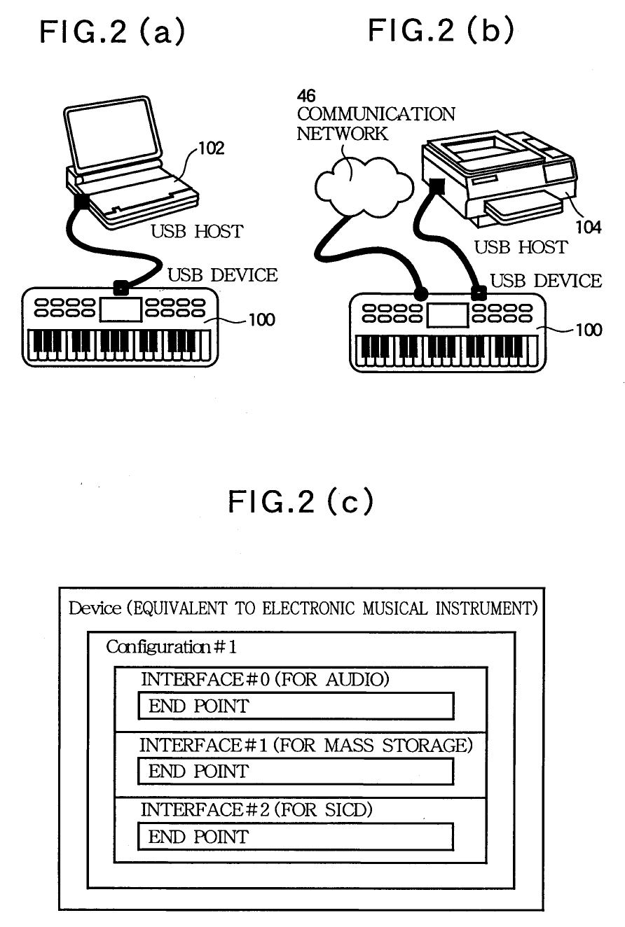

With reference to FIG. 2(C), the following describes an overview of the USB interface 34. As shown in FIG. 2(C), the USB interface 34 has endpoints for a storage device (Mass Storage), an audio device (Audio Device), and a still image capture device (SICD, Still Image Capture Device). The endpoints mean virtual ports used when the USB host transmits data or a command to the USB device. Provision of these endpoints clearly indicates that the electronic musical instrument 100 has a corresponding function.

Next, FIG. 2(a) shows a state in which the electronic musical instrument 100 as a USB device is connected with a personal computer 102 as a USB host. When connected with the personal computer 102, the electronic musical instrument 100 functions as an audio device (Audio Device) or a storage device (Mass Storage). When functioning as an audio device (Audio Device), the electronic musical instrument 100 inputs and outputs a MIDI signal, a digital audio signal and the like from and in the personal computer 102. When functioning as a storage device (Mass Storage), the personal computer 102 makes it possible to treat contents on the electronic musical instrument 100 as a “file.”

Also, when the electronic musical instrument 100 is connected with a printer 104 in compliance with the PictBridge (registered trademark as implied hereafter) standard, as shown in FIG. 2(b), the electronic musical instrument 100 functions as a still image capture device (SICD, Still Image Capture Device). That is, image data to be printed is transmitted from the electronic musical instrument 100 to the printer 104 in response to a command issued by the printer 104, whereby the image data is printed by the printer 104. The electronic musical instrument 100 according to the embodiment can directly download electronic score data and the like from the communication network 46 without passing through the personal computer 102, and can directly supplies the contents to the printer 104.

3. Operations of the Embodiment

3.1. Download Process

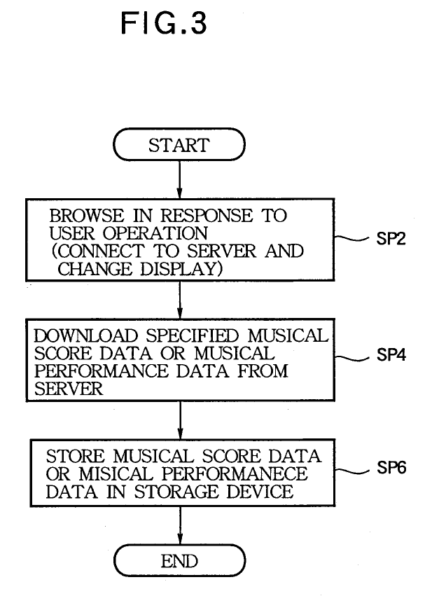

The following describes operations of the embodiment. When a user performs a specified operation on the setup operating device 6, a download routine in FIG. 3 is called. When the process proceeds to Step SP2 in FIG. 3, a Web page for the server computer 48 is accessed via the communication network 46, the contents of the Web page such as downloadable electronic score data, musical performance data, and the like are listed on the display 10. Here, when the data to be downloaded is specified by the user's operation, the process proceeds to Step SP4, wherein a specified electronic score data or a musical performance data is downloaded. When the process proceeds to Step SP6, the downloaded data is stored in RAM 22 or the external storage device 30 in a “file” format. By the way, the electronic score data may be available not only as a so-called logical musical score, but also as general image data formats such as TIFF, GIF, and BMP (bitmap).

3.2. Main Print Process

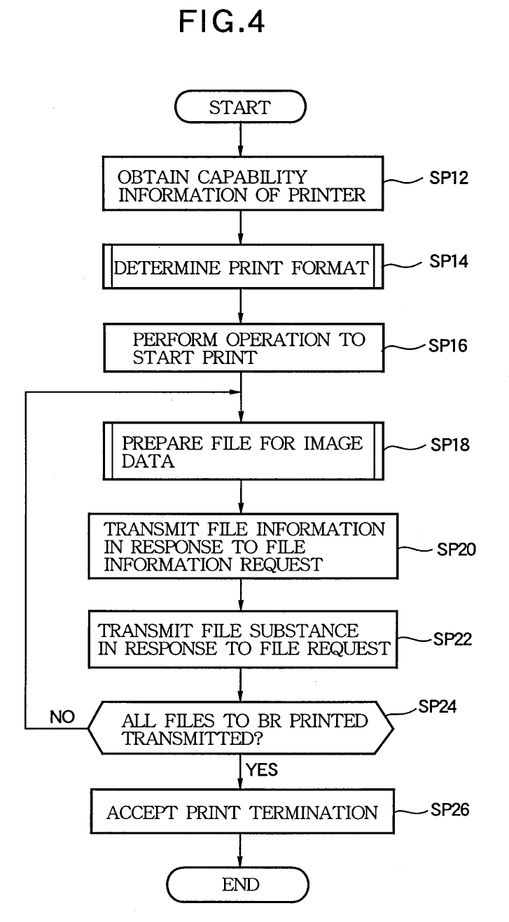

The user can select, by performing a specified operation on the setup operating device 6, a musical performance data file, a score data file, or a score data file group as a printing target from score data files or musical performance data files stored in the RAM 22 or the external storage device 30, and can also specify printing conditions such as a scaling ratio, printing quality (high or low quality), and the like. Here, the “score data file group” signifies a group of a plurality of files constituting musical score data. The case in which the score data file group is selected as a printing target is a case in which the score data file is provided in a BMP format or the like. In the BMP format, one file can store only one page (e.g., one page of musical score image), and when a musical score contains a plurality of pages, the musical score data is composed of a plurality of files (file group). On the other hand, when the score data file is available in a TIFF or GIF format or the like, one file can contain a plurality of pages of images, and in this case, one file only can be specified. A print process main routine in FIG. 4 starts when the user selects one or more printing target files and presses the print indicating button 6a of the setup operating device 6.

Now, before describing operations in FIG. 4, the following defines technical terms used for the present embodiment.

(1) Print capability information: This information is supplied from the printer 104 to the electronic musical instrument 100 and represents a function implementable on the printer 104. The print capability information includes a file format feasible with the printer 104, availability or unavailability of color printing, the presence or absence of an index print function, and the like.

(2) Filename list information: This is text data that lists filenames of image data files supplied from the electronic musical instrument 100 to the printer 104.

(3) File information: This information is transmitted to the printer 104 with respect to individual files before the image data file is transmitted from the electronic musical instrument 100 to the printer 104. The file information includes a filename of the image data file, a file format (BMP format, GIF format, and the like), a print type (color or monochrome), a resolution, a file size, and the like.

(4) Basic file information: According to the PictBridge standard, the file information can be used to specify different file formats, print types, and resolutions for individual files. The embodiment first determines the file format, the print type, and the resolution and applies them to all image data files in common. The file format, the print type, and the resolution are therefore called the basic file information.

(5) Print condition: This includes conditions such as the scaling ratio, the print quality (high or low quality), and the like.

(6) Print setup information: This is a combination of the filename list information, the print condition, and the basic file information.

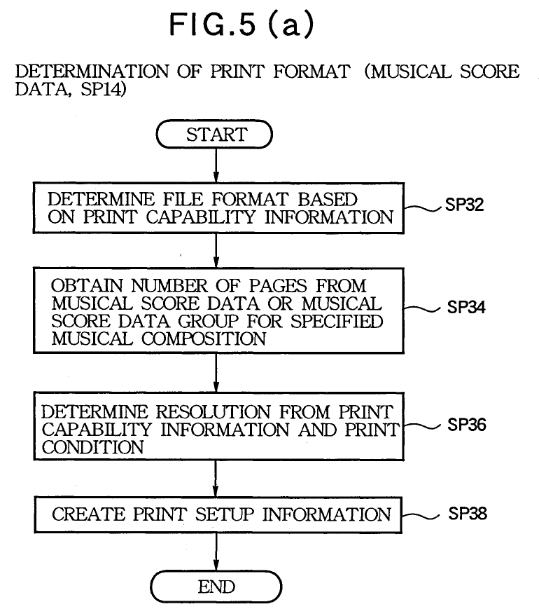

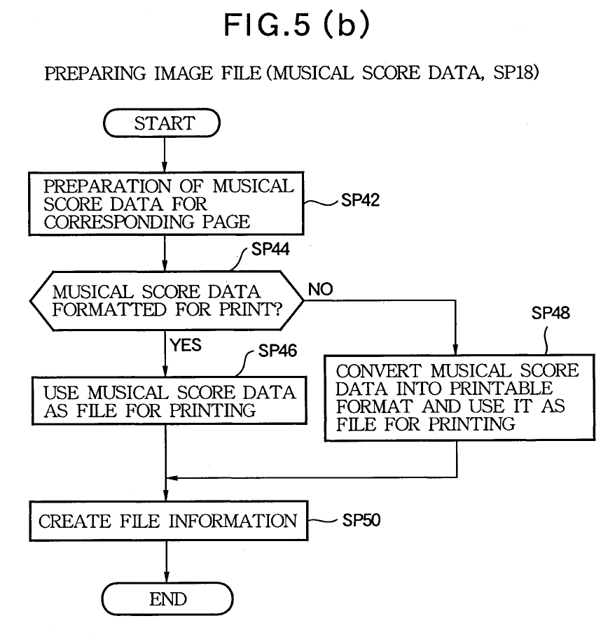

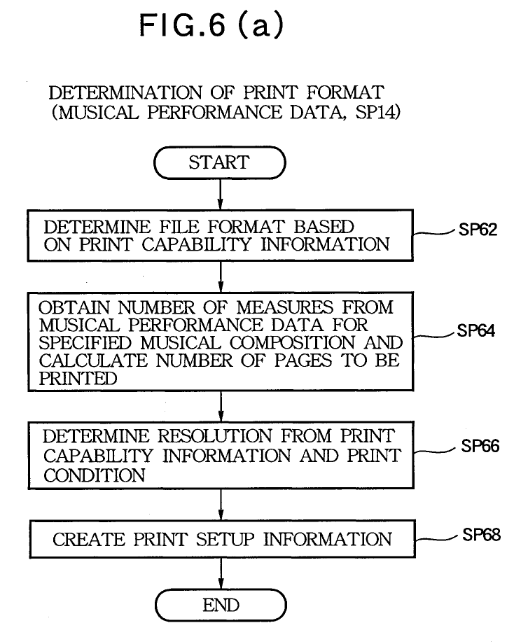

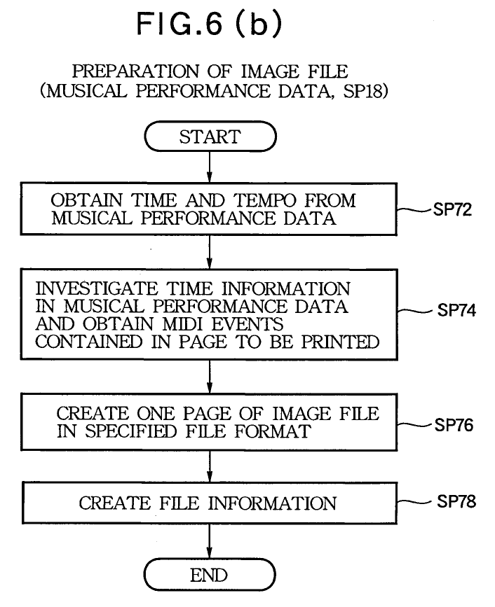

In FIG. 4, the process proceeds to Step SP12 to perform a “DPS_GetCapability operation” according to the PictBridge standard. That is, the electronic musical instrument 100 transmits a specified request event to the printer 104 and receives from the printer 104 the print capability information indicating the print capability of the printer 104. The process next proceeds to Step SP14, and a print type determination subroutine is called, in response to the type of the printing target file. That is, when the print target file is a score data file, the main routine calls a print type determination subroutine for musical score data (FIG. 5(a)), and when the print target file is a musical performance data file, the main routine calls a print type determination subroutine for musical performance data (FIG. 6(a)). Processes of these subroutines will be described later in more detail, but in any of these subroutines, the print setup information that is a combination of the filename list information and the basic file information is created. The process next proceeds to Step SP16, and a “DPS_StartJob operation” according to the PictBridge standard performed. In this operation, the electronic musical instrument transmits the filename list information and a print start request to the printer 104.

The process next proceeds to Step SP18, and an image data file preparation subroutine is called, in response to the type of a printing target file. That is, when the printing target file is a score data file, an image data file preparation subroutine for musical score data is called (FIG. 5(b)), and when the printing target file is a musical performance data file, an image data file preparation subroutine for musical performance data is called (FIG. 6(b)). Processes of these subroutines will be described later in more detail, but in any of these subroutines, the image data file to be transmitted to the printer 104 is created in a specified buffer area of the RAM 22. Here, a considerable amount of buffer area may be needed if all image data files to be transmitted to the printer are prepared at a time, and thus, in the present embodiment, the image data file is created one by one, and the image data file is transmitted to the printer each time the image data file is created.

In the printer 104, when the filename list information and the print start request are received, a file information request is transmitted to the electronic musical instrument 100. This is equivalent to a “DPS_GetFileInfo operation” according to the PictBridge standard, and this is for making an inquiry into the type or the size of an image data file subsequently transmitted from the electronic musical instrument 100. On the other hand, in the electronic musical instrument, when the image data file is created in the buffer area, the process proceeds to Step SP20, and the file information associated with the image data file previously created in the RAM 22 is transmitted to the printer 104, in response to the file information request from the printer 104. More specifically, in Step SP20, when the file information request is not received yet from the printer 104, the process waits until the request is received. And, when the file information is already received, the file information is transmitted as a response to the request.

In the printer 104, when the file information is received and is ready for receiving the substance of the image data file, a file request is transmitted to the electronic musical instrument 100. This is equivalent to a “DPS_GetFile operation” according to the PictBridge standard, and this is for requesting the electronic musical instrument 100 to transmit the actual image data file. When the file information transmission is completed at Step SP20, the process proceeds to Step S22, and the substance of the image data file is transmitted to the printer 104, in response to the file request from the printer 104. That is, when the file request is not yet received from the printer 104, the process waits until the request is received, and when the file request is received, the substance of the image data file is transmitted as a response to the request.

The process next proceeds to Step SP24, it is determined whether or not all the image data files to be printed are transmitted to the printer 104. The determination is assumed to be “NO” when an untransmitted file remains, and the process from Steps SP18 through SP24 is repeated until all the files have been transmitted. When all the files have been transmitted, the process proceeds to Step SP26 and the process waits until a “print end message” is received from the printer. The routine terminates when this message is received.

On the other hand, in the printer 104, a page buffer for storing image data to be printed on a page of paper is provided. And, when the image data file is transmitted in accordance with the process at Steps SP18 through SP24 on the electronic musical instrument 100 side, image data based on the file is stored in the page buffer. When the page buffer then becomes full, the contents of the page buffer are output to the paper. In the printer 104, the file information request is continuously transmitted to the electronic musical instrument 100 until the printer 104 receives all the listed image data files, based on the received filename list information. When all the file information requests are transmitted to the electronic musical instrument 100 and the corresponding image data files are received, the printer 104 transmits the above-described print end message to the electronic musical instrument 100 and the image data remaining in the page buffer is output to the paper. The above-mentioned operation is equivalent to a “DPS_NotifyDeviceStatus operation” according to the PictBridge standard.

3.2.1. Creation of Print Setup Information (Musical Score Data)

Next, with reference to FIG. 5(a), the following describes process contents of the print type determination subroutine for musical score data that is called for a score data file at the above-mentioned Step SP14.

In FIG. 5(a), the process proceeds to Step SP32, and a file format to be transmitted to the printer 104 is determined based on the print capability information obtained at SP12 above. For example, when the image data files in the BMP and TIFF formats can be selected as formats of the image data files that the electronic musical instrument 100 can transmit and the image data files in the BMP and GIF formats can be selected as formats of the image data files that the printer can receive, the BMP format common to both formats is selected as the image data file format.

The process next proceeds to Step SP34, the number of pages is obtained from a specified score data file or score data file group. That is, the “number of files” equals the “number of pages” for a score data file group in the BMP format or the like. Also, when the score data file is a so-called logical musical score, the number of pages is described in the file and therefore the contents are read out. Alternatively, when the score data file is created in the TIFF or GIF format, there is a case in which one file may contain a plurality of image data, so the number of pages equals the total number of pieces of image data contained in one or more print target files.

The process next proceeds to Step SP36, the resolution for printing the musical score based is determined on the print capability information and the print condition that are previously obtained. The process next proceeds to Step SP38, the print setup information is created. The filename list information is first created based on the number of pages obtained at Step SP24. For example, when the number of pages is “20,” the routine determines “20” filenames such as “img_A_{—}0001.bmp” through “img_A_{—}0020.bmp,” and the determined filenames are listed to generate the filename list information. The basic file information is created based on the file format and the resolution determined at Steps SP32 and SP36. Also, the print setup information is created by listing the filename list information, the print condition, and the basic file information, the routine of the present process terminates.

3.2.2. Preparation of an Image File (Musical Score Data)

Next, with reference to FIG. 5(b), the following describes process contents of the image data file preparation subroutine for musical score data called for a score data file at Step SP18 above. In FIG. 5(b), the process proceeds to Step SP42, and musical score data is prepared for the corresponding page. For example, when the score data file is created in the GIF or TIFF format, one file contains a plurality of pages of image, and only image data for the page to be printed this time is extracted.

Alternatively, when the score data file is provided as a so-called logical musical score, image data for the targeted page is synthesized based on font information for specifying a font in the targeted page, font positions, and the like. Namely, the image data generation part interprets the musical score data which represents a logical format of the musical score, determines fonts of musical notations according to results of the interpreting of the musical score data, and creates the image data using the fonts.

On the other hand, in the BMP format or the like, a targeted score data file can be specified because there is a one-to-one correspondence between the page to be printed and the score data file.

The process next proceeds to Step SP44, and it is determined whether or not the prepared musical score data is formatted to be capable of being printed as is. That is, when the format of the musical score data is the same as the format of the file determined at Step SP32 above, the musical score data is formatted to be capable of being printed as is. Otherwise, the musical score data is formatted to be incapable of being printed as is. Therefore, when the determination is assumed to be “YES,” the process proceeds to Step SP46, and the musical score data is simply specified as the image data file for printing. When the determination is assumed to be “NO” at Step SP44, the process proceeds to Step SP48, and the prepared musical score data is converted into the file format determined at Step SP32. The converted result is specified as an image data file for printing.

The process next proceeds to Step SP50, and the file information for the image data file is created. As mentioned above, the file information includes the image data file's filename, the file format (BMP format, GIF format, or the like), the print type (color or monochrome), the resolution, the file size, and the like. The filename among these data is contained in the file information request received from the printer 104. Also, the file format, the print type, and the resolution comply with those specified in the basic file information. The file size corresponds to the size of the image data file created at Step SP46 or SP48. The routine terminates upon completion of the above-mentioned steps.

3.2.3. Creation of the Print Setup Information (Musical Performance Data)

Next, with reference to FIG. 6(a), the following describes process contents of the print type determination subroutine for musical performance data that is called for a musical performance data file at Step SP14. In FIG. 6(a), the process proceeds to Step SP26, and the file format to be transmitted to the printer 104 is determined similarly to Step SP32 as mentioned above. The process then proceeds to Step SP64, and the number of measures from the musical performance data for the specified musical composition is obtained and the number of pages to be printed is calculated. That is, the musical performance data contains data indicative of the time and the tempo of the musical composition, so the length (time duration) per measure is found if the time and the tempo are found. In addition, since the total performance time is found from the musical performance data, the total number of measures is found by dividing the total performance time by the length per measure. Since the number of measures per page is determined based on the user-specified print condition, the number of pages is calculated by dividing the total number of measures by the “number of measures per page.” In Steps SP66 and SP68, similarly to Steps SP36 and SP38, the resolution is determined, and the print setup information is created, and then the process of the routine terminates.

3.2.4. Preparation of an Image File (Musical Performance Data)

Next, with reference to FIG. 6(b), the following describes process contents of the image data file preparation subroutine for musical performance data that is called for a musical performance data file at Step SP18. In FIG. 6(b), the process proceeds to Step SP72, and the time, the tempo, and the like for the musical composition are obtained from the musical performance data. The process next proceeds to Step SP74, time information about the musical performance data is investigated and a MIDI event contained in the page to be printed is obtained. For example, assuming that the length of one measure is “two seconds” and that the print condition is configured so as to print “20” measures on one page, the MIDI event from the beginning timing of the performance data up to “40” seconds belongs to a range of printing the first page, and the MIDI event exceeding “40” seconds up to “80” seconds belongs to a range of printing the second page.

The process next proceeds to Step SP76, and an image data file for “one” page as a print target in a specified file format, i.e., the file format determined at Step SP62 above is created. More specifically, an image of staff is generated, images such as notes are placed at positions corresponding to the event timing of each MIDI event on the staff image, and an image data file is generated as a result of superimposing these images. The process then proceeds to Step SP78, similarly to Step SP50, and file information for the image data file is created, and then the process of the routine terminates. Namely, the image data generation part interprets the musical performance data which represents a sequence of musical events of the musical piece, converts the musical events to corresponding musical notes, and arranges images of the corresponding musical notes on an image of staff to synthesize the image data.

4. Modifications

The present invention is not limited to the above-mentioned embodiment but can be variously modified as follows.

(1) While the embodiment uses the program operating on the CPU 26 to perform the print process and the like, only the program can be distributed in the form of machine readable media such as a CD-ROM and a flexible disk or can be distributed through a transmission path.

(2) The musical score printed in the embodiment is not limited to a staff form but may be a tablature.

(3) While the embodiment prints all pages of a specified score data file, only a specified page may be printed. A specific part may be printed when the musical score is printed based on a musical performance data file.

(4) The USB interface 34 may be replaced by another serial interface. The serial interface may be wired or wireless or may have both capabilities.

What is claimed is:

1. An electronic musical instrument comprising:
a tone generating part that generates performance sounds of a music piece;
a printer interface directly connected to a printer;
an image data generation part that generates image data of a musical score which corresponds to the music piece; and
a transmission part that transmits the image data to the printer for allowing the printer to print the music score according to the transmitted image data.

2. The electronic musical instrument according to claim 1, further comprising a print capability information acquisition part that acquires print capability information representing a print capability of the connected printer, wherein the image data generation part generates the image data in compliance with the acquired print capability information.

3. The electronic musical instrument according to claim 1, further comprising a download part that downloads musical score data representing the musical score via a network, wherein the image data generation part generates image data of the musical score based on the downloaded musical score data.

4. The electronic musical instrument according to claim 3, wherein the image data generation part generates image data of the musical score a page by page basis in case that the musical score data corresponds to a plurality of pages of the musical score.

5. The electronic musical instrument according to claim 3, wherein the image data generation part interprets the musical score data which represents a logical format of the musical score, determines fonts of musical notations according to results of the interpreting of the musical score data, and creates the image data using the fonts.

6. The electronic musical instrument according to claim 1, further comprising a musical performance data storage part that stores musical performance data which is used by the tone generating part to generate the performance sounds, wherein the image data generation part generates image data of the musical score based on the stored musical performance data.

7. The electronic musical instrument according to claim 6, wherein the image data generation part generates image data of the musical score a page by page basis in case that the musical performance data corresponds to a plurality of pages of the musical score.

8. The electronic musical instrument according to claim 6, wherein the image data generation part interprets the musical performance data which represents a sequence of musical events of the musical piece, converts the musical events to corresponding musical notes, and arranges images of the corresponding musical notes on an image of staff to synthesize the image data.

9. A machine readable medium for use in an electronic musical instrument having an interface directly connectable to a printer, a tone generator that generates performance sounds of a music piece, and a processor, the machine readable medium containing a program which is executable by the processor for causing the electronic musical instrument to perform a method comprising:
an image data generation step of generating image data of a musical score which corresponds to the music piece; and
a transmission step of transmitting the image data to the printer through the interface to allow the printer to print the musical score according to the transmitted image data.
